(19) United States
(12) Patent Application Publication
(10) Pub. No.: US 2008/0088530 A1
(43) Pub. Date: Apr. 17, 2008

(54) DISPLAY DEVICE

(76) Inventor: Hyun Chang Kang, Yongin-si (KR)

Correspondence Address: CHRISTIE, PARKER & HALE, LLP, PO BOX 7068, PASADENA, CA, 91109-7068, US

(21) Appl. No.: 11/780,417

(22) Filed: Jul. 19, 2007

(30) Foreign Application Priority Data
Oct. 13, 2006 (KR) 10-2006-0099811

(51) Int. Cl. G09G 3/10

(52) U.S. Cl. 345/37

(57) ABSTRACT

A display device includes a display panel for displaying images, a chassis base, at least one circuit board fixed to a planar surface of the chassis base and at least one connection cable electrically connecting the at least one circuit board to the display panel. At least one connection cable having at least one discharge element is mounted within the at least one connection cable. A cover plate is fixed to the chassis base and supporting the at least one discharge element. The cover plate has a heat resistant medium located between the cover plate and the discharge element and may include at least one discharge element alignment mark indicating a discharge element supporting area on the cover plate. The discharge element alignment mark is located on a surface of the cover plate facing the at least one discharge element.

### CROSS-REFERENCE TO RELATED APPLICATION

This application claims priority to and the benefit of Korean Patent Application No. 10-2006-0099811, filed on Oct. 13, 2006, in the Korean Intellectual Property Office (KIPO), the entire content of which is hereby incorporated by reference.

### BACKGROUND OF THE INVENTION

1. Field of the Invention

The present invention relates to a display device, and more particularly, to a plasma display device having improved heat dissipation.

2. Description of the Related Art

FIG. 1 is a partial cross-sectional view of a conventional plasma display device showing a supporting structure of a discharge element.

Referring to FIG. 1, the conventional plasma display device is provided with a discharge element 40 between a cover plate 70 and a chassis-reinforcing member 21 formed on a chassis base 20. The discharge element 40 is mounted within a connection cable 50 such that upper and lower surfaces of the discharge element contact heat-resistant media 61, 62. The connection cable 50 electrically connects a circuit board 80 and a plasma display panel 10. The plasma display panel 10 is composed of a front panel 11 and a rear panel 12, and is attached to the chassis base 20 by double-sided tape 35. A thermally conductive medium 30 is interposed between the plasma display panel 10 and the chassis base 20.

The discharge element 40 applies an address voltage according to a signal controlled in a driving circuit to selectively generate discharge in a discharge cell positioned inside the plasma display panel. Such a discharge element performs many switching operations within a short time to process various signals rapidly and simultaneously. As a result, heat is generated in the discharge element. If the heat is not dissipated effectively, the discharge element may cease to function properly. As such, the cooling of the discharge element significantly influences operational reliability of the plasma display device. Accordingly, a thermally conductive member, such as a heat-resistant medium, a cover plate, and other components, may be positioned around the discharge element.

A heat-resistant medium is attached to a conventional plasma display device without any marking guidance, often requiring a long period of time and resulting in poor attachment. As described above, if the heat-resistant medium is not attached to the cover plate within a supporting area of the discharge element, differences in the cooling efficiency of each discharge element may occur and the expected life span of the discharge element may be shortened due to heat deterioration. A discharge signal may be similarly deteriorated due to the heat-deteriorated discharge element, resulting in differences in luminance of the plasma display panel which affect image quality. Therefore, the quality of the entire plasma display device may be decreased.

### SUMMARY OF THE INVENTION

A display device is provided having, in one exemplary embodiment, a display panel for displaying images, a chassis base having a first surface for supporting the display panel and an opposing second surface, at least one circuit board fixed to a planar surface of the chassis base and at least one connection cable electrically connecting the at least one circuit board to the display panel. The display device also includes at least one connection cable having at least one discharge element mounted within the at least one connection cable. The display device further includes a cover plate fixed to the chassis base and supporting the at least one discharge element.

In one exemplary embodiment, the cover plate of the display device has a heat resistant medium located between the cover plate and the discharge element and may include at least one discharge element alignment mark indicating a discharge element supporting area on the cover plate, the discharge element alignment mark being located on a surface of the cover plate facing the at least one discharge element. The cover plate may also have at least one cover plate heat-resistant medium alignment mark for locating the cover plate heat-resistant medium on the cover plate.

In one exemplary embodiment, the cover plate heat-resistant medium, protrudes from the cover plate, is attached to the cover plate for covering the discharge element supporting area, has a plurality of heat-resistant sub-media corresponding to the number of discharge elements and covers at least two discharge element supporting areas.

The at least one discharge element alignment mark and the at least one cover plate heat-resistant medium alignment may be selected from an L-shaped line located on at least one corner of the discharge element supporting area, a plurality of dots spaced along a periphery of the discharge element supporting area and a continuous line along a periphery of the supporting area.

The chassis base of the display device, in one exemplary embodiment, includes a chassis-reinforcing material formed on the planar surface wherein the cover plate has an L-shape pair of cover legs. One cover plate leg covers the chassis-reinforcing material and the other cover plate leg covers a side of the chassis base. The at least one discharge element is supported between the chassis-reinforcing material and the cover plate

### BRIEF DESCRIPTION OF THE DRAWINGS

FIG. 1 is a partial cross-sectional view of a conventional plasma display device showing a supporting structure of a discharge element.

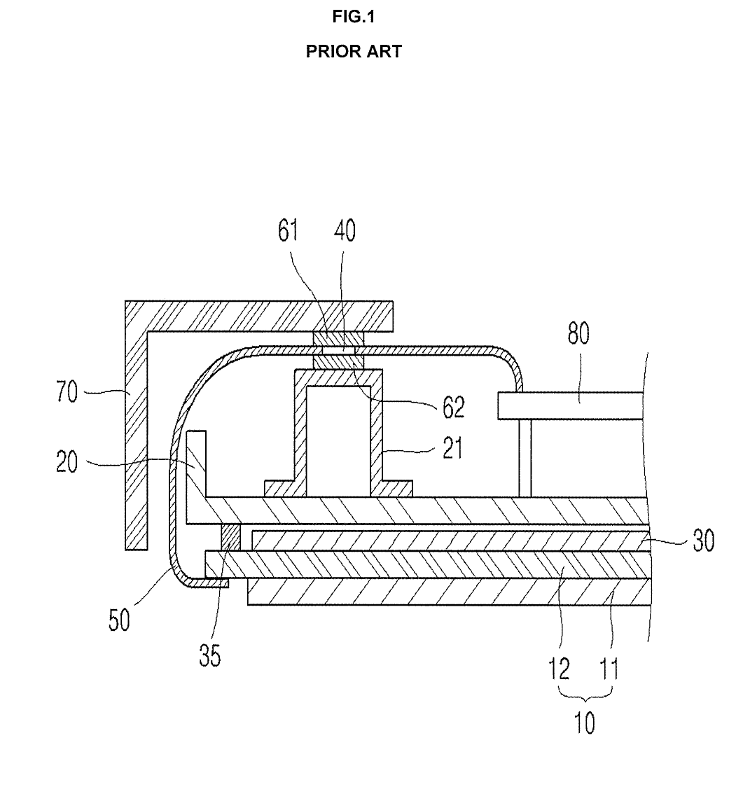

FIG. 2 is an exploded perspective view of a plasma display device according to an exemplary embodiment of the present invention.

FIG. 3a is a perspective view of a cover plate on which an alignment mark is formed.

FIG. 3b is a perspective view of a heat-resistant medium attached to the cover plate of FIG. 3a and a discharge element in contact with the cover plate.

FIG. 4 is a perspective view of a chassis-reinforcing material on which an alignment mark is formed.

FIG. 5 is a perspective view of another exemplary embodiment of a cover plate of the present invention.

FIG. 6 is a perspective view of yet another exemplary embodiment of a cover plate of the present invention.

FIG. 7a is a perspective view of still another exemplary embodiment of a cover plate of the present invention.

FIG. 7b is a perspective view of a heat-resistant sub-medium attached to the cover plate of FIG. 7a, and a discharge element in contact with the cover plate.

FIG. 8a is a partial cross-sectional view of a plasma display device of yet another exemplary embodiment of the present invention, including a supporting structure of a discharge element.

FIG. 8b is a perspective view of another exemplary cover plate on which an alignment mark is formed.

FIG. 9a is a partial cross-sectional view of still another exemplary embodiment of the present invention showing a supporting structure of a discharge element.

FIG. 9b is a perspective view of yet another exemplary cover plate on which an alignment mark is formed.

FIG. 9c is a perspective view of an exemplary leg heat-resistant medium alignment mark of the present invention.

### DETAILED DESCRIPTION

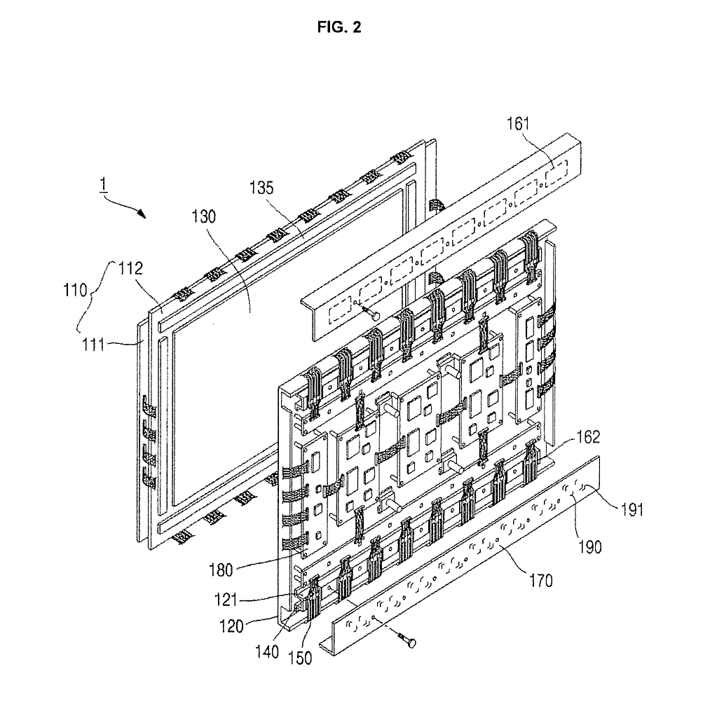

Referring to FIGS. 2 to 4, the plasma display device 1 includes a plasma display panel 110 for displaying images, a chassis base 120 for supporting the plasma display panel 110 and for fixing a circuit board 180 to a surface opposite to the plasma display panel 110, a discharge element 140 mounted within a connection cable 150 electrically connecting the circuit board 180 and the plasma display panel 110, a cover plate 170 fixed to the chassis base 120 and supporting the discharge element 140, and a cover plate heat-resistant medium 161 placed between the cover plate 170 and the discharge element 140. A discharge element alignment mark 190 indicating a discharge element supporting area 140a of the discharge element 140 may be formed on the cover plate 170.

The plasma display panel 110 includes a front panel 111 and a rear panel 112, and displays images through discharge occurring between the front panel and the rear panel. More particularly, the plasma display panel 110 includes a barrier rib provided between the front panel 111 and the rear panel 112, the barrier rib dividing a discharge cell which is filled with discharge gas to generate a plasma discharge. The plasma display panel also includes a phosphor with which an interior surface of the discharge cell is coated, and electrodes to which a voltage required to display images is applied. The plasma display panel 110 may be affixed to the chassis base 120 by double-sided tape 135 or other adhesive binding materials. Further, a thermally conductive medium 130 may be provided between the plasma display panel 110 and the chassis base 120 to protect the plasma display panel 110 from damage due to heat generated during discharge.

The chassis base 120 supports the plasma display panel 110 on one surface thereof, and supports the circuit board 180 on an opposing surface. The chassis base 120 may be made of materials with a relatively high mechanical strength compared to the plasma display panel 110. Further, the chassis base 120 conducts heat generated by the plasma display panel 110, and discharges the heat to the exterior of the plasma display device 1. Additionally, the chassis base 120 acts to block electromagnetic interference (EMI) generated while driving the plasma display panel 110. The chassis base 120 may be made of aluminum (Al) alloy or iron (Fe) alloy. However, the present invention is not limited to these specific materials, and various materials with high strength and excellent thermal and electrical conductivities may be used. The chassis base 120 may further include a chassis-reinforcing material 121 on a periphery of a chassis base planar surface.

The circuit boards 180 include a driving circuit for driving the plasma display panel 110. The circuit boards 180 are electrically connected to electrodes printed on the plasma display panel 110 through connection cables 150 provided with the discharge element 140. The circuit boards 180 may be fixed by tightening a screw into a boss insert formed on the chassis base 120.

The connection cables 150 electrically connect the electrodes printed on the plasma display panel 110 and the driving circuits formed on the circuit boards 180, while surrounding the end of the chassis base 120. The connection cables 150 include a plurality of conductive wires and at least one discharge element mounted therein. The connection cables 150 are composed of a flexible printed circuit (FPC) on which a plurality of printed circuits are formed.

A discharge element 140 mounted within a connection cable 150 applies an address voltage to the electrodes of the plasma display panel 110 according to a signal controlled in the driving circuit to selectively generate discharge in the discharge cell positioned inside the plasma display panel 110. In one exemplary embodiment, the discharge element 140 is located between the cover plate 170 and the chassis-reinforcing material 121. The discharge element 140 contacts heat-resistant media 161, 162 on upper and lower surfaces thereof to dissipate heat generated during the driving of the plasma display panel. The discharge element 140 may include a driver IC.

The connection cable 150 and the discharge element 140 may be formed by a tape carrier package (TCP) method such that at least one discharge element is mounted on printed circuit tape. However, in the present invention, the method for mounting the connection cable 150 and the discharge element 140 is not limited thereto, and various mounting methods, such as chip on film (COF), and others, may be used.

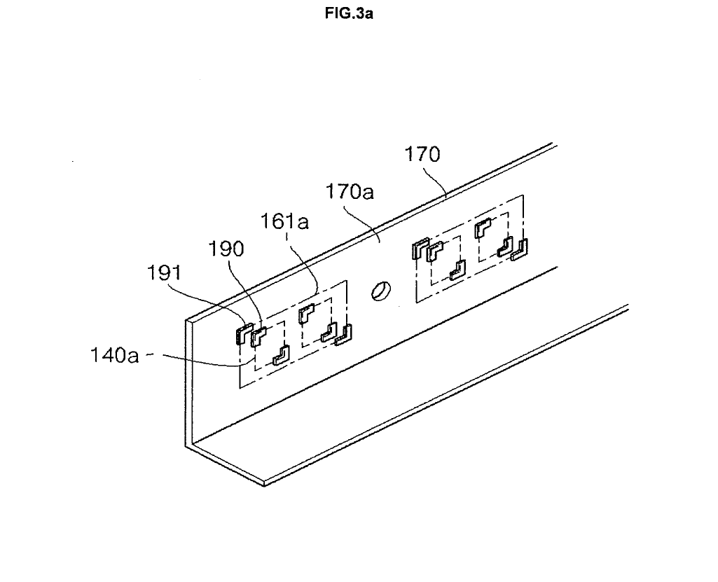

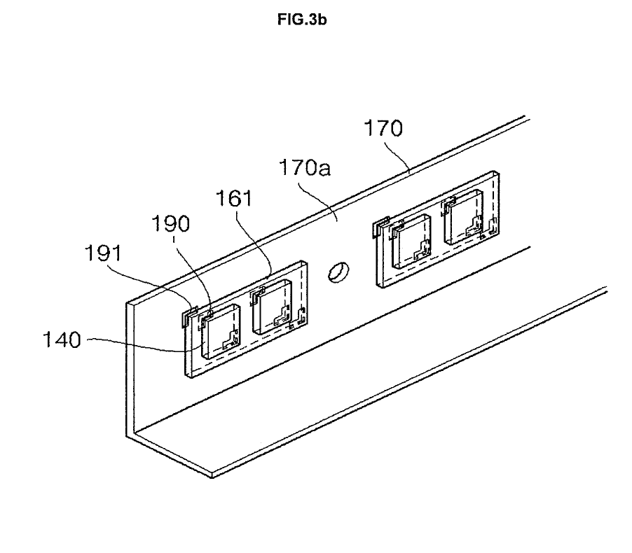

The cover plate 170 may be L-shaped and may be linked with the chassis-reinforcing material 121 by a screw to cover a top surface of the chassis-reinforcing material 121 and a side of the chassis base 120. The cover plate 170 supports the connection cable 150 and the discharge element 140 to ensure firm fixation thereof. Further, the cover plate 170 acts as a heat-resistant plate which dissipates heat generated by the discharge element 140 to the exterior of the plasma display device 1. Further, the cover plate 170 prevents the connection cable 150 and the discharge element 140 from accumulating debris, and accordingly prevents malfunction thereof caused by the debris. In one exemplary embodiment, the cover plate 170 is made of materials with excellent thermal conductivity and may be made of the same materials as the chassis base 120, such as aluminum (Al) alloy or iron (Fe) alloys. As shown in FIG. 3a, the cover plate 170 may include the discharge element alignment mark 190 indicating a discharge element supporting area 140a of the discharge element on an interior upper surface 170a facing the discharge element 140.

In one exemplary embodiment the discharge element supporting area 140a is formed uniformly on the interior upper surface 170a of the cover plate 170 to support the connection cable 150 and the discharge element 140 effectively.

The discharge element alignment mark 190 may be marked to correspond to a periphery of the discharge element supporting area 140a. In one exemplary embodiment as shown in FIG. 3a, the discharge element alignment mark 190 may be formed in an L-shape corresponding a corner of the discharge element supporting area 140a. In another exemplary embodiment, two alignment marks 190 may be incorporated such that one mark is located in opposite peripheral corners of the discharge element supporting area 140a. Such alignment marks effectively indicate a square or rectangular-shaped discharge element supporting area 140a.

The discharge element alignment mark 190 may protrude from the cover plate 170. In an exemplary embodiment, the discharge element alignment mark 190 may be formed by punching the cover plate 170 or by pressing the cover plate 170. In one exemplary embodiment, the discharge element alignment mark 190 protrudes to a height recognizable by the naked eye to allow the discharge element 140 to be properly attached to the cover plate heat-resistant medium 161. However, in the present invention, the forming method of the alignment mark for discharge element 190 is not limited thereto, and various forming method can be used. Such methods may be, for example, a scribing method to form a groove or an intaglio line on an interior upper surface 170a of the cover plate 170 using sharp tools, such as a knife, a drill and others, a punching method to form an intaglio shape by applying pressure to the cover plate 170, and a printing method to directly print the shape of the alignment mark for discharge element 190 on the discharge element supporting area 140a of the cover plate 170.

The cover plate heat-resistant medium 161 may be generally flat and may be attached to the cover plate 170 to contact at least one discharge element 140. The cover plate heat-resistant medium 161 is formed to cover the discharge element supporting area 140a and is attached to the interior upper surface 170a of the cover plate 170. The alignment mark is particularly useful when there are a plurality of discharge elements 140 to be attached to the cover plate heat-resistant medium 161 because the contact area between the cover plate heat-resistant medium 161 and the discharge elements 140 increases as the number of discharge elements increase.

The cover plate heat-resistant medium 161 thermally contacts the discharge element 140 to absorb heat generated by the discharge element 140. The absorbed heat is discharged to the exterior via the cover plate 170. The cover plate heat-resistant medium 161 may include an adhesive layer on its upper and lower surfaces to allow attachment to the cover plate 170 and to the discharge element 140.

In one exemplary embodiment, the adhesive layer is made of thermally conductive materials. The material of the cover plate heat-resistant medium 161 may be silicone, acryl, urethane or graphite, and ferrite-based nanoparticle or conductive filler may be mixed therewith to improve thermal conductivity. However, the material of the cover plate heat-resistant medium 161 is not limited thereto, and other materials with excellent thermal conductivity may be used.

The cover plate 170 may also include cover plate heat-resistant medium alignment mark 191 on the interior upper surface 170a thereof to aid in the attachment of the cover plate heat-resistant medium 161 to the cover plate. The cover plate heat-resistant medium alignment mark 191 may be marked on the periphery of an reinforcing member heat-resistant medium attachment area 161a. In one exemplary embodiment, the cover plate heat-resistant medium alignment mark 191 may be formed into the same shape and by using the same method as the discharge element alignment mark 190.

The chassis-reinforcing material 121 may be attached to the chassis base 120 on the periphery of the chassis base by a screw or others attachment means. The chassis-reinforcing material 121 is positioned to reinforce the strength of the chassis base 120 and to support the plasma display panel 110 and the circuit board 180. Further, the chassis-reinforcing material 121 dissipates heat generated in the discharge element 140 to the exterior through the chassis base 120. The chassis-reinforcing material 121 may be made from the same material as the chassis base 120.

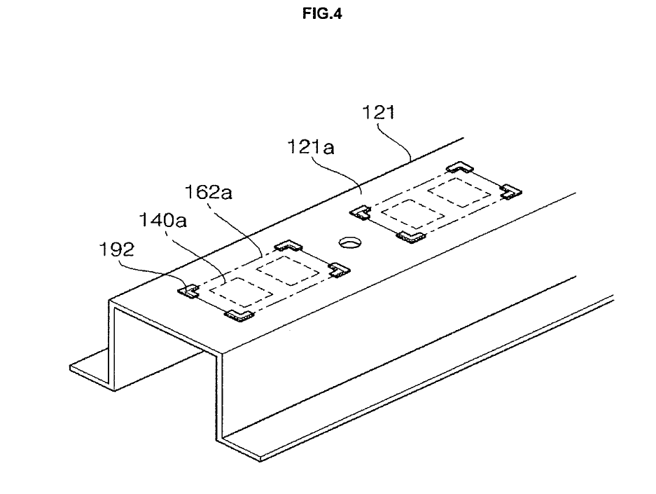

As shown in FIG. 4, the chassis-reinforcing material 121 may also allow for the placement of a reinforcing member heat-resistant medium 162 on the exterior facing upper surface 121a thereof which may contact and cools the discharge element 140. The chassis-reinforcing material 121 may further include a heat-resistant medium alignment mark 192 formed on a periphery of an exterior upper surface attachment area 162a, to prevent the reinforcing member heat-resistant medium 162 from being misaligned when it is attached. The alignment mark 192 may be formed into the same shape and by the same method as the alignment mark for discharge element 190.

For clarity, the cover plates 170 shown in FIG. 2 convey different components—the heat resistant medium 161 is shown on the upper cover plate and the alignment marks 190 and the cover plate heat-resistant medium alignment marks 191 are shown on the lower cover plate. However, as shown in FIG. 3b, the cover plate 170 includes the heat resistant medium 161, the alignment marks 190, and the cover plate heat-resistant medium alignment marks 191 on the interior area 170a thereof. Further, although the discharge element 140 may be mounted within the connection cable 150, the connection cable 150 is not shown in FIG. 3b for clarity.

The plasma display device 1, as described above, allows uniform cooling of the discharge element 140 by including at least one discharge element alignment marks 190 on the cover plate 170, permitting the cover plate heat-resistant medium 161 to be attached to contact the entire discharge element. Accordingly, varying luminance of the plasma display panel 110 caused by deterioration of a discharge signal due to a heat-deteriorated discharge element 140 is reduced or eliminated, and the luminous efficiency of the plasma display panel 110 is improved, resulting in increased quality of the entire plasma display device 1.

Further, the alignment mark 190 acts as an attachment guide for the cover plate heat-resistant medium 161, and thus allows the time for adhering the cover plate heat-resistant medium 161 to the cover plate 170 to be reduced and increases the likelihood of accurate attachment of the cover plate heat-resistant medium 161 to a desired position. Consequently, product yield improves.

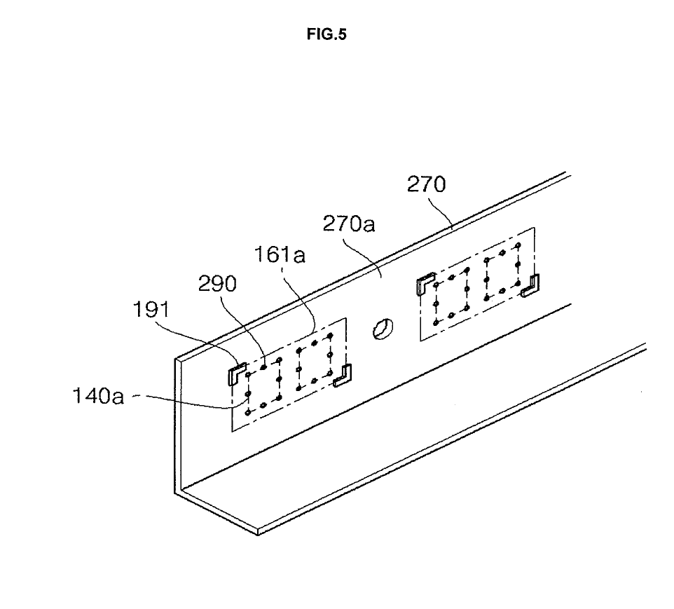

A plasma display device according to other exemplary embodiments of the present invention will be described below with respect to FIGS. 5-7b. Since some components are common between the exemplary embodiments, only the differences will be highlighted.

Referring to FIG. 5, a cover plate 270 including a discharge element alignment mark 290, and a cover plate heat-resistant medium attachment area 161a is shown.

The discharge element alignment mark 290 indicates a discharge element supporting area 140a on the interior upper surface 270a of the cover plate 270 facing the discharge element 140. The discharge element alignment mark 290 may include a plurality of dots marking the periphery of the discharge element supporting area 140a. Similarly to previously described alignment marks 190, the discharge element alignment mark 290 may protrude from the cover plate 270 and may be formed to protrude by the methods described above. The cover plate 270 may further include a cover plate heat-resistant medium alignment mark 191 on a reinforcing member heat-resistant medium attachment area 161a of the cover plate formed to cover the discharge element alignment mark 290.

The cover plate heat-resistant medium 161 is attached to the cover plate 270 to cover the discharge element alignment mark 290, and contacts the entire area of the discharge element 140 to cool the discharge element 140 effectively. Further, the cover plate heat-resistant medium 161 is attachable to the cover plate 270 within the discharge element supporting area 140a of the discharge element 140.

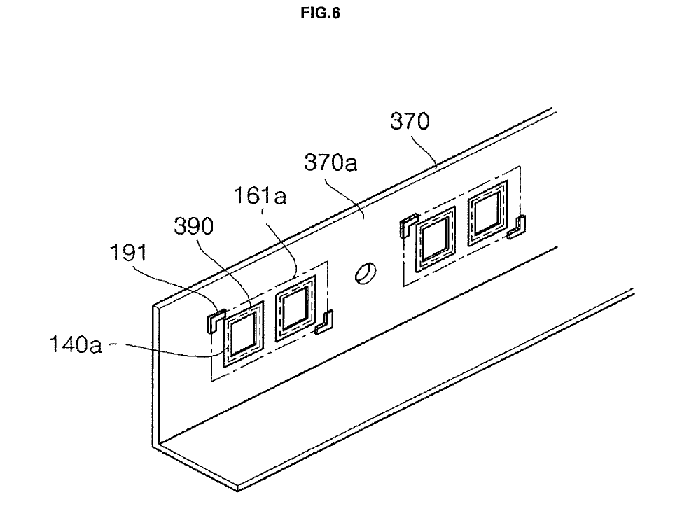

Referring to FIG. 6, a cover plate 370 including a discharge element alignment mark 390, and a cover plate heat-resistant medium attachment area 161a is shown.

The discharge element alignment mark 390 indicates a discharge element supporting area 140a on the interior upper surface 370a of the cover plate 370 facing the discharge element 140. The discharge element alignment mark 390 may be formed to indicate the entire periphery of the discharge element supporting area 140a. In one exemplary embodiment, the discharge element alignment mark 390 may be shaped to correspond to the discharge element 140 supported by the cover plate 370. By being shaped to correspond to the discharge element 140, the discharge element alignment mark 390 indicates the discharge element supporting area 140a of the discharge element 140 relatively accurately.

As described above, the discharge element alignment mark 390 may protrude from the cover plate 370 and may be formed by, for example, scribing, punching and printing methods. The cover plate 370 may also include an cover plate heat-resistant medium alignment mark 191 on an reinforcing member heat-resistant medium attachment area 161a for attachment of the cover plate heat-resistant medium 161.

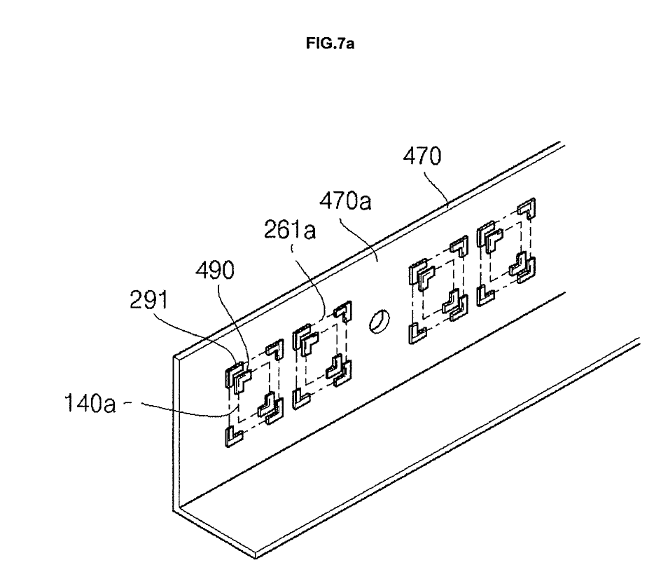

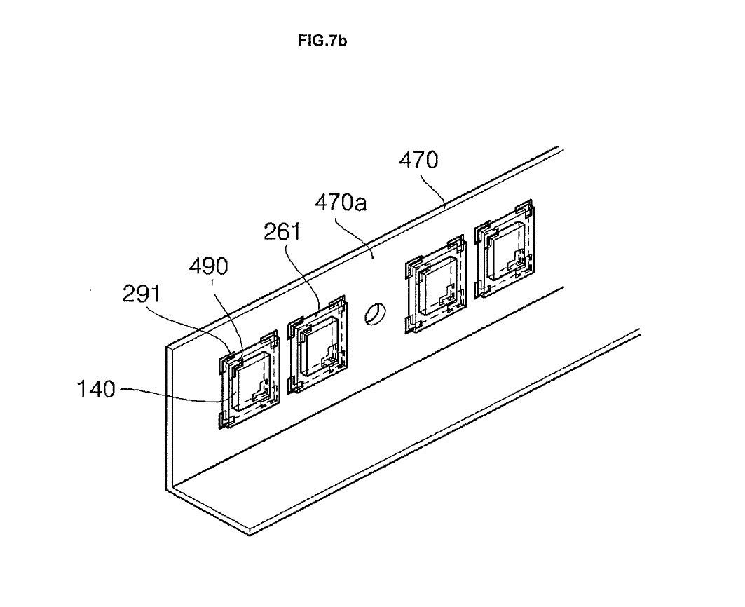

Referring to FIGS. 7a and 7b, a cover plate 470 including a discharge element alignment mark 490, and a heat-resistant sub-medium 261 is shown. The discharge element 140 is mounted to the connection cable 150, but the connection cable 150 is not shown in FIGS. 7a and 7b for clarity.

The cover plate 470 includes a discharge element alignment mark 490 indicating a discharge element supporting area 140a on the interior upper surface 470a of the cover plate facing the discharge element 140. A heat-resistant sub-medium 261 is placed between the cover plate 470 and the discharge element 140 to cover the discharge element alignment mark 490. The cover plate 470 may further include a cover plate heat-resistant medium alignment mark 291 on a sub-heat resistant medium attachment area 261a.

The heat-resistant sub-medium 261 is formed to cover the discharge element supporting area 140a marked by the discharge element alignment mark 490 for a single discharge element 140. Accordingly, the number of heat-resistant sub-media 261 corresponds to the number of discharge elements 140, limiting the amount of material necessary for each heat-resistant sub-medium 261 and decreasing the cost of the plasma display device.

The discharge element alignment mark 490 and the cover plate heat-resistant medium alignment mark 291 may be the same shape as the alignment marks previously described and may be formed by the methods previously described.

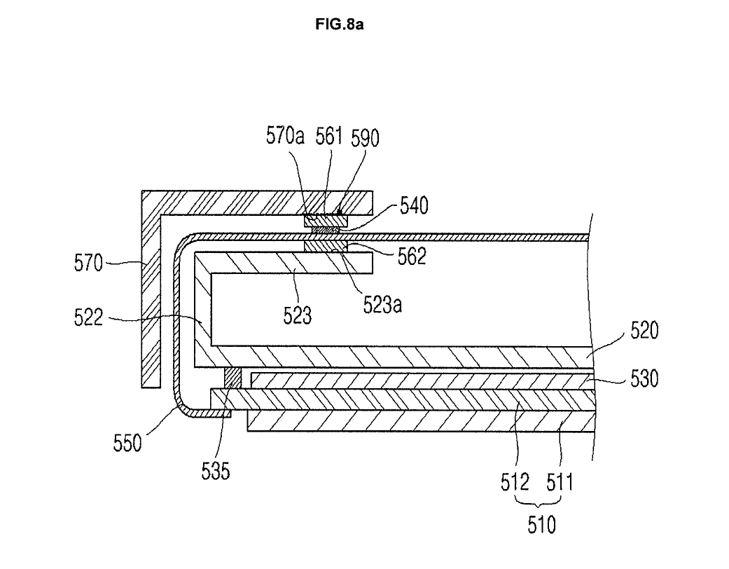

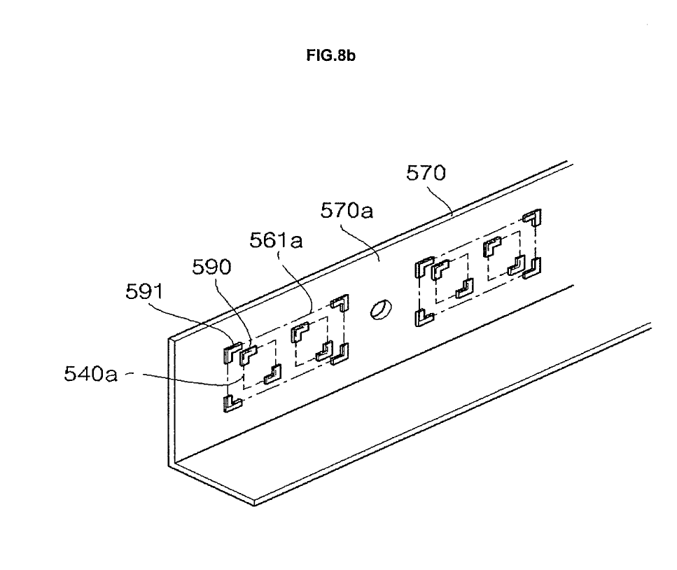

A plasma display device according to yet another embodiment of the present invention will be described with respect to FIGS. 8a and 8b. The plasma display device includes a plasma display panel 510 including a front panel 511 and a rear panel 512, and a chassis base 520 supporting the plasma display panel 510 and fixing a circuit board (not shown) to a surface facing away from the plasma display panel 510, and including legs 522, 523 formed integrally with the chassis base at an end thereof. The chassis base 520 includes at least one discharge element 540 mounted on a connection cable 550 electrically connecting the circuit board and the plasma display panel 510, a cover plate 570 fixed to the chassis base 520 and supporting the connection cable 550 and the discharge element 540 between the legs 522, 523, and a cover plate heat-resistant medium 561 placed between the cover plate 570 and the discharge element 540. The plasma display panel 510 is attached to the chassis base 520 by double-sided tape 535. A thermally conductive medium 530 may be provided between the plasma display panel 510 and the chassis base 520. The cover plate 570 includes a discharge element alignment mark 590 indicating a discharge element supporting area 540a.

The legs include a side leg 522 formed substantially perpendicular to the chassis base 520, and a rear leg 523 extending from the side leg substantially perpendicular to the chassis base. Such legs 522, 523 reinforce the chassis base 520. The legs 522, 523 may be integral with the chassis base 520 eliminating the need for external reinforcing material for the chassis base.

The discharge element 540 and the connection cable 550 are supported between the rear leg 523 and the cover plate 570. The discharge element 540 and the connection cable 550 can be mounted by, for example, the TCP method and the COF method, among others.

The cover plate 570 may be generally L-shaped and positioned to cover the side and rear legs 522, 523 of the chassis base 520. The cover plate 570 includes a discharge element alignment mark 590 on the interior upper surface thereof and on which the cover plate heat-resistant medium 561 is attached to cover the discharge element supporting area 540a of at least one discharge element 540. The cover plate 570 may also include an cover plate heat-resistant medium alignment mark 591 on a periphery of an attachment area 561a for the cover plate heat-resistant medium 561 to allow the cover plate heat-resistant medium 561 to be attached to the cover plate. The alignment marks 590, 591 may be formed into the same shape and by the same method as alignment marks described above.

The chassis base 520 may further include a heat-resistant medium 562 on the exterior-facing surface 523a of the rear leg 523 which contacts the connection cable 550. A rear leg heat-resistant medium alignment mark (not shown) for the leg heat-resistant medium 562 may be located on an attachment area for the heat-resistant medium 562 and may be formed into the same shape and by the same method as alignment marks described above.

Since the cover plate heat-resistant medium alignment mark 591 allows the cover plate heat-resistant medium 561 attached to the cover plate 570 to contact the entire surface of the discharge element 540, the cooling effect of the discharge element 540 improves, improving the quality of the entire plasma display device. Further, the cover plate heat-resistant medium alignment mark 591 guides attachment of the cover plate heat-resistant medium 561 to the discharge element supporting area 540a, allowing faster attachment.

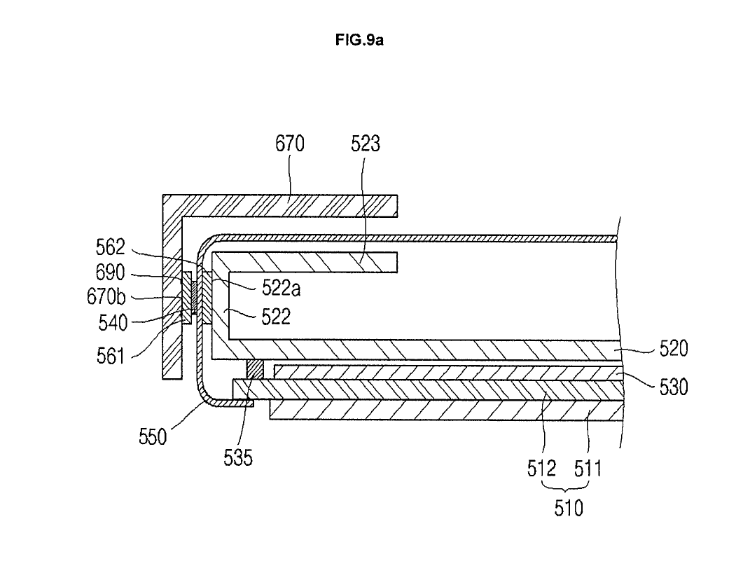

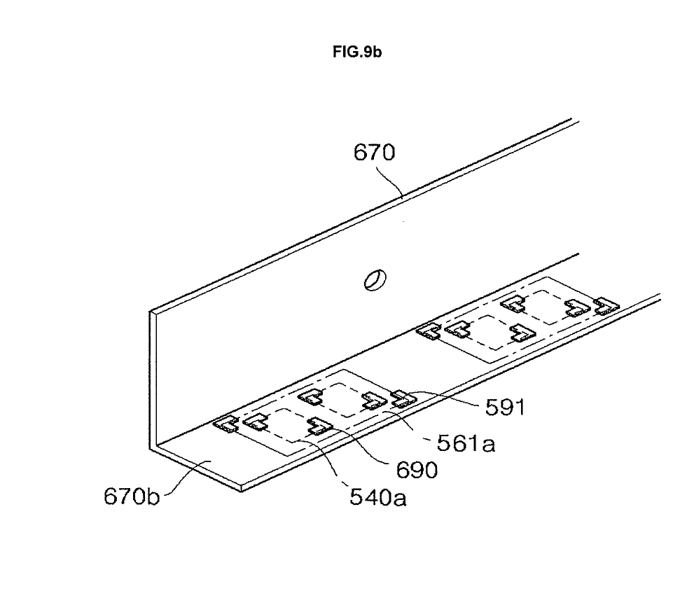

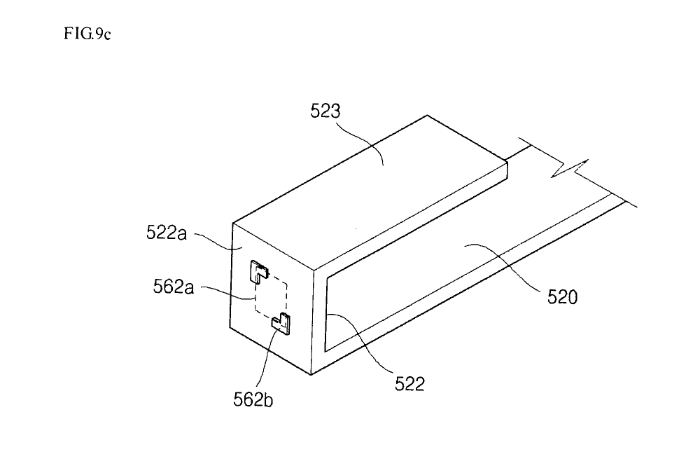

A plasma display device according to still another exemplary embodiment of the present invention will be described with respect to FIGS. 9a and 9b. A cover plate 670 supporting the connection cable 550 and the discharge element 540, and a cover plate heat-resistant medium 561 to be attached to the cover plate 670 are shown, the cover plate 670 including a discharge element alignment mark 690 indicating a discharge element supporting area 540a.

The discharge element 540 and the connection cable 550 are supported between the side leg 522 and the cover plate 670. In one exemplary embodiment, the chassis base 520 does not include the rear leg 523.

The cover plate 670 includes the discharge element alignment mark 690 on the interior-facing side 670b thereof. The cover plate heat-resistant medium 561 is attached to the cover plate 670 and covers a discharge element supporting area 540a for at least two discharge elements 540. The cover plate 670 may further include a cover plate heat-resistant medium alignment mark 591 as a guide for attaching the cover plate heat-resistant medium 561 to the cover plate. The alignment marks 690, 591 may be formed into the same shape and by the same method as described above.

The chassis base 520 includes a side-leg heat-resistant medium 562 on the exterior surface 522a of the side leg 522 which contacts the connection cable 550. With reference also to FIG. 9c, a leg heat-resistant medium alignment mark 562b located on a leg heat-resistant medium attachment area 562a of the heat-resistant medium for leg 562 may be further formed in the same shape and by the same methods described above.

The cover plate heat-resistant medium 561 is attached to the cover plate 670 to contact the entire surface of the discharge element 540 and allows uniform cooling of the discharge element 540. Thus, cooling efficiency is improved and accordingly, the quality of the plasma display device is improved. Further, the discharge element alignment mark 690 acts as a guide in the attachment of the cover plate heat-resistant medium 561 to the discharge element supporting area 540a of the discharge element 540, allowing reduced attachment time.

The present invention is not limited to a certain desirable embodiment as described above. It should be understood by those of ordinary skill in the art that various replacements, modifications and changes in the form and details may be made therein without departing from the spirit and scope of the present invention as defined by the following claims. Therefore, it is to be appreciated that the above described embodiments are for purposes of illustration only and are not to be construed as limitations of the invention.

What is claimed is:

1. A display device, comprising:
a display panel for displaying images;
a chassis base having a first surface for supporting the display panel and an opposing second surface;
at least one circuit board fixed to a planar surface of the chassis base;
at least one connection cable electrically connecting the at least one circuit board to the display panel, the at least one connection cable having at least one discharge element mounted within the at least one connection cable;
a cover plate fixed to the chassis base and supporting the at least one discharge element; and
a cover plate heat-resistant medium located between the cover plate and the discharge element,
wherein the cover plate includes at least one discharge element alignment mark indicating a discharge element supporting area on the cover plate, the discharge element alignment mark being located on a surface of the cover plate facing the at least one discharge element.

2. The display device of claim 1, wherein the cover plate heat-resistant medium is attached to the cover plate for covering the discharge element supporting area.

3. The display device of claim 2,
wherein the cover plate heat-resistant medium further comprising a plurality of heat-resistant sub-media corresponding to the number of discharge elements, and
wherein the cover plate heat-resistant medium covers at least two discharge element supporting areas.

4. The display device of claim 2, wherein the at least one discharge element alignment mark is selected from:
an L-shaped line located on at least one corner of the discharge element supporting area,
a plurality of dots spaced along a periphery of the discharge element supporting area; and
a continuous line along a periphery of the supporting area.

5. The display device of claim 4, wherein the at least one discharge element alignment mark protrudes from the cover plate.

6. The display device of claim 1, wherein the cover plate further comprises at least one cover plate heat-resistant medium alignment mark for locating the cover plate heat-resistant medium on the cover plate.

7. The display device of claim 6, wherein the at least one cover plate heat-resistant medium alignment mark is selected from:
an L-shaped line located on at least one corner of the discharge element supporting area;
a plurality of dots spaced along a periphery of the discharge element supporting area; and
a continuous line along a periphery of the discharge element supporting area.

8. The display device of claim 7, wherein the cover plate heat-resistant medium alignment mark protrudes from the cover plate.

9. The display device of claim 1, wherein the chassis base further comprises a chassis-reinforcing material formed on the planar surface;
wherein the cover plate has an L-shape pair of cover legs, one cover plate leg covering the chassis-reinforcing material and the other cover plate leg covering a side of the chassis base; and
wherein the at least one discharge element is supported between the chassis-reinforcing material and the cover plate.

10. The display device of claim 9, wherein a reinforcing material heat-resistant medium is attached to the chassis-reinforcing material, the reinforcing material heat-resistant medium contacting the at least one discharge element.

11. The display device of claim 10, wherein the chassis-reinforcing material further comprises at least one reinforcing material heat-resistant medium alignment mark indicating a reinforcing material heat-resistant medium attachment area.

12. The display device of claim 1, wherein the connection cable and the at least one discharge element are tape carrier package mounted.

13. The display device of claim 1,
wherein the chassis base further comprises a chassis base side leg and a chassis base rear leg integrally formed with the chassis base, the chassis base side leg extending perpendicularly from an end of the chassis base and the chassis base rear leg extending perpendicularly from the chassis base side leg;
wherein the cover plate has an L-shaped pair of cover plate legs, one cover plate leg covering the chassis base side leg and the other cover plate leg cover the chassis base rear leg; and
wherein the at least one discharge element is supported between the cover plate and the chassis base side leg and/or the chassis base rear leg.

14. The display device of claim 13, wherein the cover plate heat-resistant medium is attached to the cover plate for covering the discharge element supporting area.

15. The display device of claim 14,
wherein the cover plate heat-resistant medium further comprises at least one heat-resistant sub-media corresponding to the at least one discharge element; and
wherein the cover plate heat-resistant medium covers at least two discharge element supporting areas.

16. The display device of claim 14, wherein the at least one discharge element alignment mark is selected from:
an L-shaped line located on at least one corner of the discharge element supporting area;
a plurality of dots spaced along a periphery of the discharge element supporting area; and
a continuous line along a periphery of the discharge element supporting area.

17. The display device of claim 16, wherein the at least one discharge element alignment mark protrudes from the cover plate.

18. The display device of claim 13, wherein the cover plate further comprises at least one cover plate heat-resistant medium alignment mark for locating the cover plate heat-resistant medium on the cover plate.

19. The display device of claim 18, wherein the at least one cover plate heat-resistant medium alignment mark is selected from:
an L-shaped line located on at least one corner of the discharge element supporting area;
a plurality of dots spaced along a periphery of the discharge element supporting area; and
a continuous line along a periphery of the discharge element supporting area.

20. The display device of claim 19, wherein the at least one cover plate heat-resistant medium alignment mark protrudes from the cover plate.

21. The display device of claim 13, further comprising a leg heat-resistant medium attached to one of the chassis base rear leg and the chassis base side leg, the leg reinforcing material heat-resistant medium contacting the connection cable.

22. The display device of claim 21, wherein the chassis base further comprises at least one leg heat-resistant medium alignment mark indicating a leg heat-resistant medium attachment area.

23. The display device of claim 13, wherein the connection cable and the at least one discharge element are tape carrier package mounted.

24. The display device of claim 1, wherein the display panel is a plasma display panel.

25. A display device comprising:
a display panel for displaying images;
a chassis base having a first surface for supporting the display panel and an opposing second surface;
at least one circuit board fixed to a planar surface of the chassis base;
at least one connection cable electrically connecting the at least one circuit board to the display panel, the at least one connection cable having at least one discharge element mounted within the at least one connection cable;
a cover plate fixed to the chassis base and supporting the at least one discharge element; and
a cover plate heat-resistant medium located between the cover plate and the discharge element,
wherein the cover plate includes a cover plate heat-resistant medium alignment mark for locating the cover plate heat-resistant medium on the cover plate.

26. The display device of claim 25, wherein the display panel is a plasma display panel.
